(19) United States
(12) Patent Application Publication
(10) Pub. No.: US 2019/0245318 A1
(43) Pub. Date: Aug. 8, 2019

(54) Concentric Cylindrical Circumferential Laser

(71) Applicants: Ronald LaComb, West Greenwich, RI (US); Kevin LaComb, Higganum, CT (US); Sallie Townsend, West Hartford, CT (US)

(72) Inventors: Ronald LaComb, West Greenwich, RI (US); Kevin LaComb, Higganum, CT (US); Sallie Townsend, West Hartford, CT (US)

(73) Assignee: Ronald LaComb, West Greenwich, RI (US)

(21) Appl. No.: 16/252,928

(22) Filed: Jan. 21, 2019

Related U.S. Application Data
(60) Provisional application No. 60/623,476, filed on Oct. 29, 2004.

(51) Int. Cl. H01S 3/081; H01S 3/083; H01S 3/067

(52) U.S. Cl. CPC H01S 3/0813; H01S 3/06791; H01S 3/083

(57) ABSTRACT

The present disclosure relates to a ring-type laser system supporting circumferential radial emission. A cylindrical ring waveguide provides optical confinement in the radial and axial dimensions supporting a plurality of traveling wave modes with various degrees of confinement. The waveguide contains a gain media which is gain tailored to offset modal confinement factors of the modal constituency to favor radial emission. The selected modes radiate energy as they circulate the laser resonator with a 360 degree output coupler. The design is applicable toward both micro-resonators and resonators much larger than the optical wavelength, enabling high output powers and scalability. The circumferential radial laser emission can be concentrated by positioning the cylindrical ring laser inside a three-dimensional conical mirror thereby forming a laser ring of light propagating in the axial dimension away from the surface of the laser, which can be subsequently collimated for focused using conventional optics.

### CROSS-REFERENCE TO RELATED APPLICATIONS

This application claims the benefit of U.S. Provisional Application No. 62/623,476 filed on Jan. 29, 2018. The entire disclosure of the above application is incorporated herein by reference.

### FIELD OF THE INVENTION

The present application relates to a laser system and method having a cylindrical or circular resonator with a means of mode tailoring utilizing both index of refraction tailoring and gain tailoring to constitute and excite a set of radially emitting modes exiting the resonator along the circumference. The circumferential laser emission is imaged utilizing three-dimensional reflectors to image or concentrate the laser emission. More specifically it relates to a means for increasing the lasing aperture and scaling of the radially mode area to scale the average output power.

### REFERENCES CITED

Patent: LaComb et al. U.S. Pat. No. 7,492,805
Patent LaComb et al. U.S. Pat. No. 6,256,330
Patent LaComb 20020227842

### BACKGROUND

This section provides background information related to the present disclosure. A laser consists of an optical resonator, a optically active gain media housed within the resonator and a pump source to produce photon generation within the resonator. Laser threshold is reached when the small signal round trip gain equals the resonator losses. The main function of the optical resonator is to impart a modal structure and shape to the energy emitted by a laser and to provide positive optical feedback to promote stimulated emission of photons within a defined modal set. Loses within the optical resonator can vary significantly from one mode to another. Modal losses are characterized by their Q-factor which is defined as the ratio of energy stored to power dissipated per unit angular frequency ω. In general, high Q modes within a laser resonator supporting a plurality of modes are first to be amplified within a laser resonator and eat up the available gain effectively starving the lower Q modes supported by the resonator.

In general a laser requires a gain loaded resonator or cavity enabling optical circulation and amplification. In general, different types of laser resonators are used depending upon the laser type, common resonator types include linear open resonators and reflecting waveguide types both of which can be configured in a linear or in ring type geometries. Open resonators are typically formed by two or more mirrors separated by an expanse containing a gain media and are categorized as stable or unstable cavities.

Another type of resonator, a cavity resonator, confines the radiation in three dimensions, causing standing waves in all three dimensions (x,y &z), the number of supported modes M over a frequency interval of ω+Δω is proportional to the resonator volume V multiplied by ω². The use of cavity resonators for high frequencies is typically limited to micro-resonators with the volume on the cavity on the order of the wavelength λ. Use of optical cavity resonators for V>λ³ is not practical for the separation between resonances ie ratio of ΔM/ω decreases with frequency, while spectral line ω/Q increases with frequency, therefore, typical optical cavity resonators with volumes greater than the wavelength support overlapping spectral lines causing the resonator to lose its resonance properties.

Open resonators differ from a cavity resonator in two aspects, the transverse resonator sidewalls are removed while the longitudinal “end face” reflectors are retained. Secondly, the dimensions of the resonator are much larger than the optical wavelength λ. The open resonator geometry enables only the modes propagating along the resonator axis (or deviating slightly) to be excited, thereby significantly reducing the number of modes supported by the cavity. Cavity resonators are not feasible for optical wavelengths, for the number of modes supported by the resonator increases to the point where the resonator loses its resonator characteristics.

Conventional ring lasers or traveling-wave lasers are based upon two classes of resonators, waveguide based resonators and open resonators. Open resonator ring lasers employ three or more mirrors to create traveling waves rotating clockwise and counter clockwise around the resonator, a partial reflective mirror is typically used for an output coupler allowing a portion of the laser beam to exit the resonator.

Conventional traveling wave lasers use waveguides to form a ring or race track architecture. Micro-disk lasers consist of laser resonators of geometric size on the order of the operational wavelength typically in the form a disk or toroid. Since traveling wave disk resonators are a form of cavity resonator, their geometries are limited to micro-resonators, as disk diameters become much larger than the operational wavelength the energy separation between modes becomes so small that the resonator cannot differentiate between different wavelengths and therefore loses its resonator behavior. This requirement restricts conventional traveling wave disk laser geometries to diameters on the order of 10 s to 100 microns.

Micro-ring lasers utilize a substrate waveguide (semiconductor, polymer or other) formed into a circular geometry in the shape of a disk or ring with diameters on the order of the wavelength. The resulting modes are in general Whispering Gallery Modes (characterized by very high Q-factors). The laser radiation is of the traveling type, and typically harnessed by coupling waveguides to the rings or by incorporating optical gratings to instill vertical emission. Due to the small volume of the micro-cavity output power are small often less than a mWatt. Other types of micro-ring resonators include: race-track, ring, torrid, fiber-optic, bottle type; spherical and cylindrical geometries all of which typically utilize whispering gallery mode (WGM) resonators coated with an active media (quantum dots or thin coating of optically active media) to achieve lasing. These waveguides are also micro-resonators with waveguides designed to trap the light around the circumference of the cylinder, sphere, toroid or other circular geometry.

The vast majority of laser systems utilize the open resonator concept where a resonator is used to amplified light between two end mirrors, creating a laser beam exiting from one of the mirrors configured as an output coupler. Traveling wave resonators employ open resonator configurations consisting of three or more mirrors, or cavity-type resonators in the shape of micro-rings or micro-disk geometries. Lasers in general are designed to produce uniform output beams with minimum distortions due to thermal gradients or saturation effects. Power limitations are often associated with beam width and beam quality degradation or component failure. These metrics often depend upon dependencies of modal constituency on resonator volume and power handling limitations of mirrors or other laser components establishing a tradeoff between beam quality and beam power. Typically, as the resonator volume is increased, the resonator modal constituency is altered causing a degradation in beam quality, increasing the power without increasing the resonator volume can cause thermal degradation or catastrophic optical mirror damage (COD) at the output facet or coupler when power thresholds are exceeded. Accordingly, there exists a need for further improvements in laser systems toward power scalability and beam quality.

This disclosure introduces a gain and index tailored cylindrical ring laser supporting circumferential lasing. The cylindrical ring laser resonator can be designed as a micro-resonator or to have geometries much larger than the optical wavelength. Power scaling is supported by the ability of the cylindrical ring resonator to maintain similar modal constituencies for a wide range of diameters, with the output facet or coupler consisting of the entire circumference of the resonator, thereby reducing thermal limitations and COD limits while maintaining consistent output beam quality.

### OBJECTS AND ADVANTAGE

Power scaling of conventional laser architectures is limited by thermal and power density limitations of materials making up the laser systems, attempts of power scaling by increasing the resonator volume leads to degradation in beam quality, due to the onset of additional modes running in the laser. In semiconductor lasers, power is often limited by facet failure while solid state lasers are often limited by thermal fracture limits. The object of this invention is to provide a new type of laser employing a gain and index tailored cylindrical ring resonator capable of circumferential radial emission, this enables geometric power scaling with consistent beam performance. The resonator design of this patent allows cylindrical ring cavities to serve as optical resonators at geometries much larger than the wavelength supported by gain medial housed inside the waveguide. Through index tailoring of the radial index profile of the cylindrical ring waveguide, similar radial mode constituencies can be supported for cylindrical waveguides of increasing diameters. This is accomplished by tailoring the change in index of refraction step between the cylindrical ring waveguide region and the interior and exterior regions for a given cylindrical ring waveguide width (similar to defining the change in index between the fiber core and cladding of a step index optical fiber for a given core diameter). The cylindrical ring resonator is designed to support a set of traveling wave modes consisting a plurality of radial modes, one or more of a plurality of axial modes and a plurality of degenerate azimuthal modes propagating in both the clockwise and counterclockwise directions around the cylindrical ring waveguide with varying degrees of confinement as defined by their respective Q-factors. By tailoring the radial variation of the index of refraction cylindrical ring resonators can be designed to support a set of radial modes varying in Q-factor from high Q-factor Whispering Gallery modes to radial modes with lower Q-factors supporting significant radial emission. Modal analysis of cylindrical ring resonator demonstrates that radial modes with significant intensity profiles at inner radii are attributed to lower Q-factor modes while high Q-factor modes possess radial intensity profiles concentrated at the outer radius of the cylindrical ring waveguide. Through proper index tailoring, the interior radial modes can be designed to support intermediate Q-factors capable of efficient radial emission. Gain tailoring is employed to offset the gain provided to a subset of radial modes with selected Q-factors over that of the high Q-factor modes (known as Whispering Gallery Modes), by establishing a gain confining region which substantially overlaps with a desired set of radial modes. Gain tailoring is accomplished by confining the radial extent of gain amplification to lower radii of the cylindrical ring waveguide which overlap substantially with the selected Q-factor modes while gain starving high Q-factor modes which have intensity profiles concentrated at the outer radius of the cylindrical resonator. By utilizing both index and gain tailoring, cylindrical ring resonators can scale in diameter while maintaining similar laser modal constituency while maintaining efficient radial emission when pump actuation exceed threshold levels. Operational modes are characterized as traveling wave modes circulating around the cylindrical ring resonator radiating energy as they propagate, the integrated radiation loss incurred in one revolution is analogous to mirror loss in a standing wave laser resonator. Laser threshold is met when the optical gain of a particular mode matches the modal loss, consisting of the mirror loss and any material loss present in the waveguide. The output mirror for this type of novel laser resonator extends around the entire circumference of the cylindrical ring resonator. Circumferential radial emission increases output power for acceptable levels of power density and thermal density by spreading out the beam energy around the cylindrical ring waveguide. Beam quality is maintained for cylindrical ring waveguides of larger diameter and associated cavity volume for all modes are radial. For semiconductor lasers COD is significantly mitigated for the entire circumference of the outer cylindrical ring constitutes the output laser mirror, enabling much higher powers to be achieved before reaching failure levels. For solid state lasers the thermal breakdown often causing gain media fracturing or modal degradation can be mitigated, by the larger modal volumes supported thereby enabling power scaling. The radial emission is harnessed by a three dimensional mirror designed to redirect the radial laser emission. Alternatively, the cylindrical ring waveguide can be designed to support lower Q-factor modes, or pumped below threshold, thereby supporting predominantly spontaneous light generation, producing a LED instead of laser diode.

### SUMMARY

This section provides a general summary of the disclosure, and is not a comprehensive disclosure of its full scope or all of its features.

In one aspect the present disclosure relates to a laser system. The laser system may comprise of a concentric cylindrical ring resonator (forming a multi-layered annular disk waveguide capable of optical confinement in both the radial and axial dimension) housing a gain medium and a pump source to excite the gain media within gain confined regions which substantially overlap with a preferred set of radial modes supporting efficient radial emission while gain starving low loss high Q-factor modes. The optical gain region is spatially limited by tailoring the extents of the overlap between the gain media and pump region thereby defining a gain confining region. The gain confining regions tailors optical amplification in both the radial and azimuthal dimension to significantly overlap with modal intensities of selected modes, thereby offsetting modal gain factors between the selected modes and remainder of modal constituency. The resonator supports at least one axial mode ether by the formation of an index guiding axial waveguide or by limiting the gain confining region in axial extent. The radial mode constituency is directly related to the radial extent of the cylindrical ring width decoupled from the overall diameter, enabling modal geometries far exceeding the order of the optical wavelength. The cylindrical ring waveguide supports a set of radial modes with varying radial emission components (defined by their respective Q-factors), with the high Q-factor modes having very narrow radial mode intensities concentrated about the outer radius of the ring resonator while lower Q-factor modes possess wider radial intensities extending deeper into the ring resonator. The spatial uniqueness of the radial mode set is exploited by designing the gain confining regions to substantial overlap with a preferred set of modes thereby offsetting modal gains (MG) of the various Q-factor modes to favor amplification of intermediate value Q-factor modes over that of low and high Q-factor modes to favor radial laser emission. The modal constituency supported by the gain and index tailored cylindrical ring laser resonator includes a set of radial and axial modes each with a distinct resonator wavelength and associated set of degenerate azimuthal modes capable of efficient circumferential radial emission Laser emission may be concentrated and or redirected with cylindrical or conical reflective mirrors and lenses.

In another aspect the present disclosure relates to a laser system comprising of a concentric multi-layered solid-state cylindrical ring laser resonator. The laser system may comprise of a concentric multi-layered cylindrical resonator forming a cylindrical ring waveguide which houses an optically active media. Optical gain is confined to a region smaller in diameter than the outer cylindrical ring resonator diameter by tailoring the radial profile of the overlap between the pump source and gain media. The gain confinement region may also include azimuthal segments to establish a radial and azimuthal variation in optical gain. The gain confining region optimizes the spatial modal overlap of gain profile with a subset of radial and azimuthal modes for efficient radial emission. The subset of modes selected possess low-moderate Q-factors, while high Q-factor modes do not substantially overlap with the tailored gain confinement regions and therefor are not amplified. Application of adequate pump actuation allows the selected modal set to be amplified and reach threshold, thereby supporting circumferential radial emission. The radial emission may be redirected in the axial direction by a three dimensional cylindrical or conical reflective mirror and subsequently collimated or focused by additional optical lenses.

In another aspect the present disclosure relates to a method of forming a semiconductor cylindrical ring laser. The laser system may comprise of a concentric cylindrical resonator formed by forming a ring waveguide in a semiconductor epitaxial media housing a gain layer. Unique to this resonator design, the cylindrical ring waveguide can support dimensional geometries far exceeding micro-resonator dimensions while maintaining optical resonator functionality. The semiconductor epitaxial media contains an optically active layer and waveguide layers to establish an optical waveguide in the perpendicular direction, the semiconductor epitaxial layers also include p-type and n-type doping layers and top and bottom contacts to enable an applied current to create optical photons in the active layer when properly biased. The top electrical contact is radially and azimuthally tailored to establish a current injection profile and an associated optical gain profile in both the radial and azimuthal direction, thereby offsetting optical modal-gains of the modal constituency, favoring a subset of the radially emitting optical modes. Upon sufficient current injection, laser threshold is reached and the laser supports radial emission around the entire circumference of the laser resonator.

In another aspect the present disclosure relates to a laser system. The laser system may comprise of a concentric cylindrical resonator in the shape of a multi-radial layered cylindrical tube comprising of at least one optically active layer within a cylindrical optical waveguide layer, an optical pump source which overlaps with gain media to form a gain confining region. Optical gain is tailored in the radial and axial dimension by the overlap of the optical pump and gain media. The gain confining region is limited to a central ring smaller in diameter than the outer cylindrical resonator surface and to a selected axial length. The optical pump is designed to overlap appreciably with the central gain media and may include azimuthal features to establish a radial and azimuthal variation in optical gain, to offset the modal gain of selected radial and azimuthal modes over that of the remainder of the modes confined by the cylindrical waveguide. The preferred modal set includes radially emitting optical modes with moderate Q-factors over that of high Q-factors modes thereby supporting efficient circumferential laser emission upon lasing.

In another aspect the present disclosure relates to a method of forming a laser system. The laser system may comprise of a multi-layer concentric cylindrical ring resonator with geometric shape of a bottle resonator. The bottle resonator limits the axial mode set to one of a plurality of axial modes. The resonator further comprises of at least one optically cylindrical active layer within a cylindrical optical waveguide layer within the bottle region, and an optical pump source which overlaps substantially with the gain region. Axial index tailoring and gain tailoring is employed to limit the number of axial modes supported by the concentric cylindrical resonator. The gain confining regions are limited to a central cylindrical region smaller in diameter than the outer cylindrical resonator surface to offset modal gain of radially emitting modes over that of confined traveling wave modes to optimize radial emission. Upon sufficient optical pump actuation, the concentric cylindrical bottle laser resonator lasers in a circumferential fashion.

In another aspect the present disclosure relates to a laser system. The laser system consisting of a multi-cylindrical waveguide in the form of a micro-disk attached to a distal end of an optical fiber or light pipe. The disk resonator includes a multi-layered cylindrical media housing a gain media, a gain confining region formed by the overlap of the gain media and pump radiation to a radial region less than the radial extent of the cylindrical disk resonator, the disk thickness is limited to confine a single axial mode, upon sufficient actuation radial modes are amplified which support circumferential radial emission.

In another aspect the present disclosure relates to a laser array formed by placing one cylindrical ring laser inside another with each cylindrical ring laser of a larger diameter, with the plurality of laser elements assembled concentric about a common center.

In another aspect the present disclosure relates to a laser array formed by placing one cylindrical ring laser after another stacked in the axial dimension.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. The accompanying drawings, which are incorporated into and constitute a part of the specification, illustrate specific embodiments of the apparatus, systems, and methods and, together with the general description given above, and the detailed description of specific embodiments serve to explain the principles of the apparatus, systems, and methods.

In the drawings:

FIG. 1A shows a high level diagram (Top-Side View) of one example of a cylindrical ring laser resonator including, a schematic of the radial index of refractive profile forming the cylindrical ring resonator and a schematic of the intensity profiles attributed to three classes of optical modes supported by the cylindrical ring resonator defined by their respective Q-factors. The cylindrical ring waveguide includes a gain confining region with offsets the modal confinement factors to favor amplification of intermediate Q modes which support efficient circumferential laser emission.

FIG. 1B shows a simplified three-dimensional drawing of a semiconductor ridge wave-guide cylindrical ring laser resonator in accordance with this disclosure. The drawing includes details specific to the semiconductor epitaxial structure and the radially and axially tailored gain and refractive index features of the cylindrical ring resonator.

FIG. 1C shows a laser system of FIG. 1B with azimuthally and radially segmented gain confining region in accordance with present disclosure;

FIG. 1D shows a radial cross-sectional view of an example of a semiconductor ridge waveguide cylindrical ring resonator with the outer circumferential surface of the resonator forming the output mirror, the gain confinement regions is formed by limiting current flow into the active regions to specific localities in accordance with the present disclosure.

FIG. 1E shows a schematic of the index of refraction radial profile of a cylindrical ring resonator with gain tailored optical region as related to FIG. 1D. Mode intensity profiles are also included, illustrating the how gain tailoring establishes a gain region which selectively overlaps with a subset of the confined radial modes amplifying radial emitting modes while gain starving whispering gallery modes (WGM).

FIG. 1F shows a radial cross-sectional view of another example of a semiconductor ridge waveguide cylindrical resonator which employs a multi-step ridge etch to tailor the refractive index radial profile of the cylindrical resonator, whereby the output mirror surface has a larger radius than the outer radius of the cylindrical ring waveguide.

FIG. 1G shows a schematic of the radial profile of the refractive index of a multi-step cylindrical ring resonator with gain tailored optical region as related to FIG. 1F. Mode intensity profiles are also included, illustrating the how gain tailoring establishes a gain region which selectively overlaps with a subset of radial modes supporting efficient radial emission.

FIG. 1H shows a schematic of a cylindrical ring laser in accordance of this disclosure positioned within a three-dimensional conical reflector, thereby reflecting the radial laser emission in the axial dimension to form a ring of light emanating perpendicularly from the surface of the laser resonator.

FIG. 1I shows a schematic of a cylindrical ring laser as related to FIG. 1H where the reflected radiation is further concentrated or collimated by an optical lens or optical system.

FIG. 1J shows a cross section of a multi-cylindrical ring laser array with concentric cylindrical ring laser resonators each placed within a three-dimensional conical mirror, each element and reflector of increasing diameter positioned concentrically one inside the other, thereby forming a multi-ringed laser emission pattern propagating normal to the laser surface.

FIG. 2A shows a schematic of a multi-sectioned cylindrical ring laser made from a gain loaded solid state matrix doped with Rare Earth dopants, cooled from the central region with multiple optical pump configurations are illustrated which cause photon generation in a gain confined region, thereby providing a modal gain offset favoring radial modes which support circumferential radial emission.

FIG. 2B shows cross-sectional and top view schematics of a cylindrical ring laser as related to FIG. 2A mounted on a heat conducting substrate with selected photon amplification with periodically placed optical fibers delivering pump energy to gain confining regions.

FIG. 3A shows a schematic of a multi-layered cylindrical ring laser resonator, formed from a multi-layered cylindrical structure, with selected pump methodology defining a gain confining region with both radial and axial confinement, including axial attenuation lines, thereby supporting radial laser emission. The cylindrical rod laser may be fashioned to allow pump radiation to flow down the center or liquid cooling.

FIG. 3B shows a schematic of a multi-layered cylindrical ring laser with a bottle type geometry, thereby providing axial confinement limiting the number of axial modes in accordance with this disclosure.

FIG. 4A shows a schematic of a multi-layered cylindrical ring laser in accordance with this disclosure featuring multiple laser elements stacked in the axial dimension, including attenuation lines, with circumferential radial emission reflected by a three-dimensional reflector to form a concentrated line of laser radiation

FIG. 4B shows a schematic of a multi-layer multi-segmented cylindrical ring laser in accordance with this disclosure stacked in the axial dimension, with radial radiation being concentrated with a three-dimensional mirror.

FIG. 5a shows a schematic of a solid-state cylindrical ring laser resonator in accordance with this disclosure, featuring a micro-disk geometry being pumped by a single optical fiber, to establish radial laser emission exiting the cylindrical ring micro-disk resonator.

FIG. 5b shows a schematic of multiple cylindrical ring laser disks in accordance with this disclosure stacked in the axial dimension about a central cylindrical structure, one of an optical fiber, light pipe or cylindrical tube.

### DETAILED DESCRIPTION

Example embodiments will now be described more fully with reference to the accompanying drawings.

Referring to the drawings, to the following detailed description, and to incorporated materials, detailed information about the apparatus, systems, and methods is provided including the description of specific embodiments. The detailed description serves to explain the principles of the apparatus, systems, and methods described herein. The apparatus, systems, and methods described herein are susceptible to modifications and alternative forms. The application is not limited to the particular forms disclosed. The application covers all modifications, equivalents, and alternatives falling within the spirit and scope of the apparatus, systems, and methods as defined by the claims.

The present invention includes a cylindrical ring optical resonator providing radial and axial optical confinement, thereby supporting a set of radial and axial modes with degenerate azimuthal modes, a gain confining region for offsetting modal confinement factors favoring a lasing modal constituency consisting of a limited radial and axial modal set possessing Q-factors which support radial emission around the circumference of the device. The multi-layered gain tailored resonator design allows cylindrical ring laser resonators to maintain optical resonator functionality over a wide range of cylindrical diameters far exceeding the optical wavelength, while supporting circumferential laser emission exiting about a 360 degree output mirror surface. This enables power scaling beyond what is achievable utilizing conventional traveling wave laser architectures.

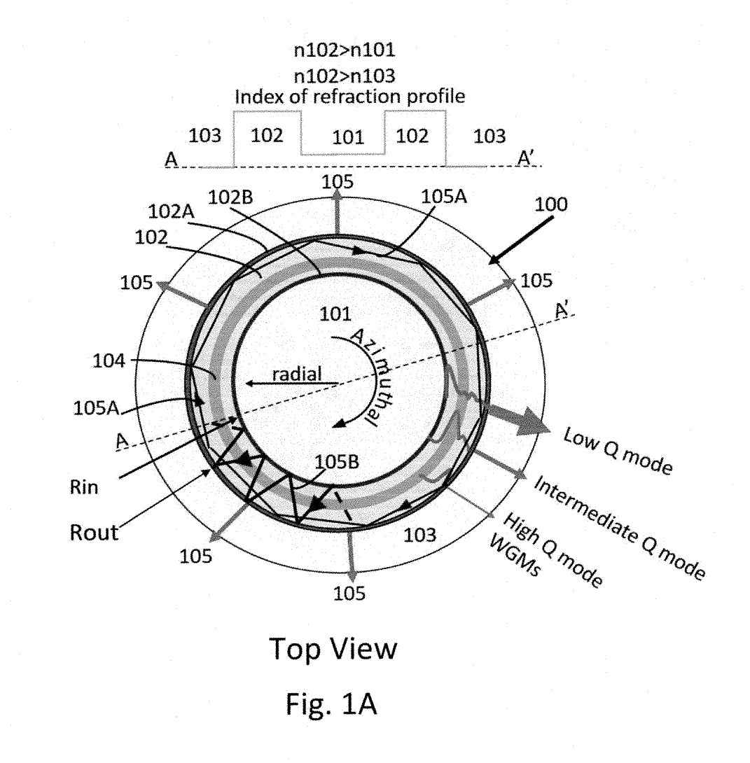

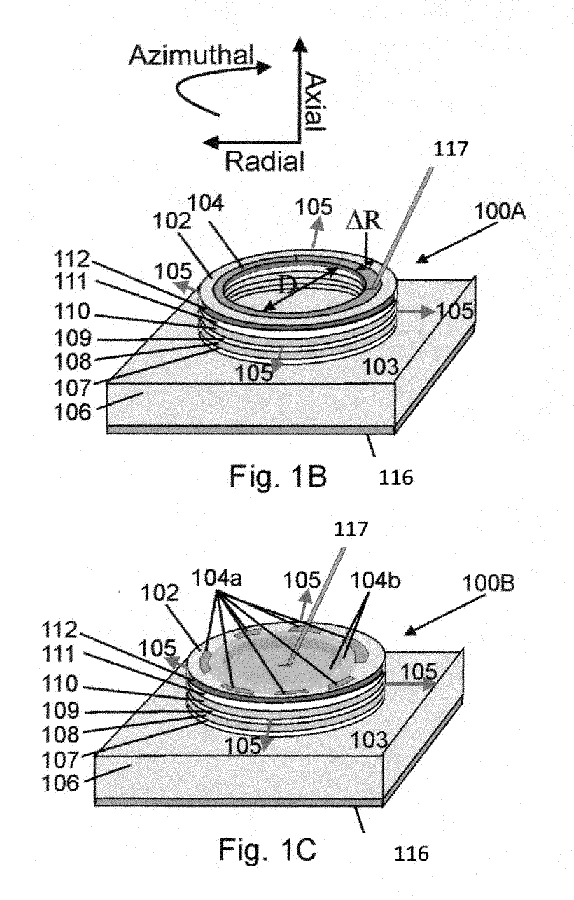

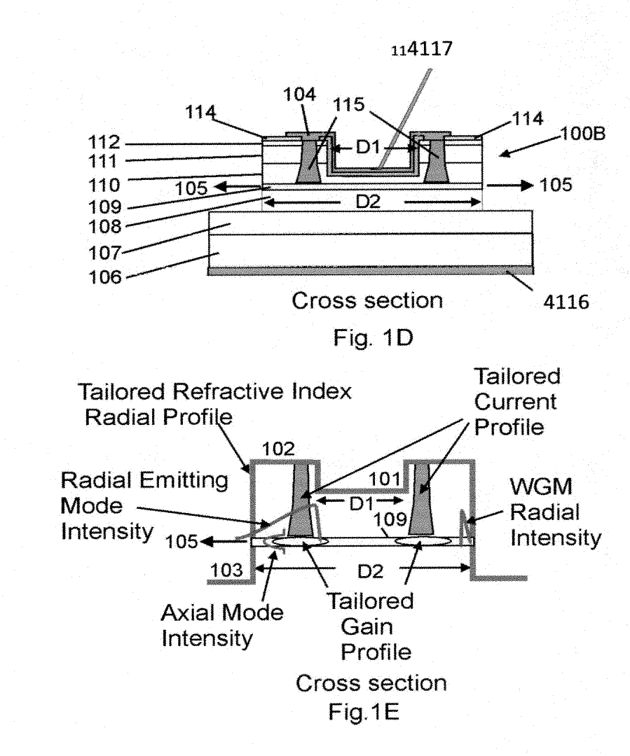

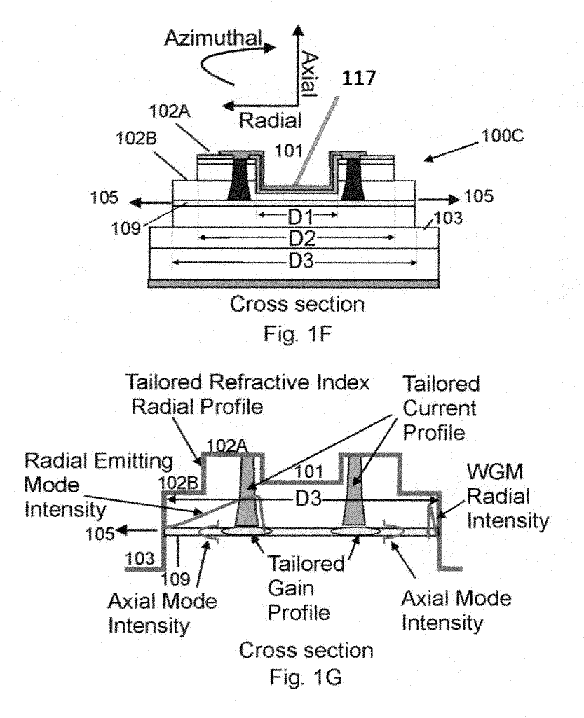

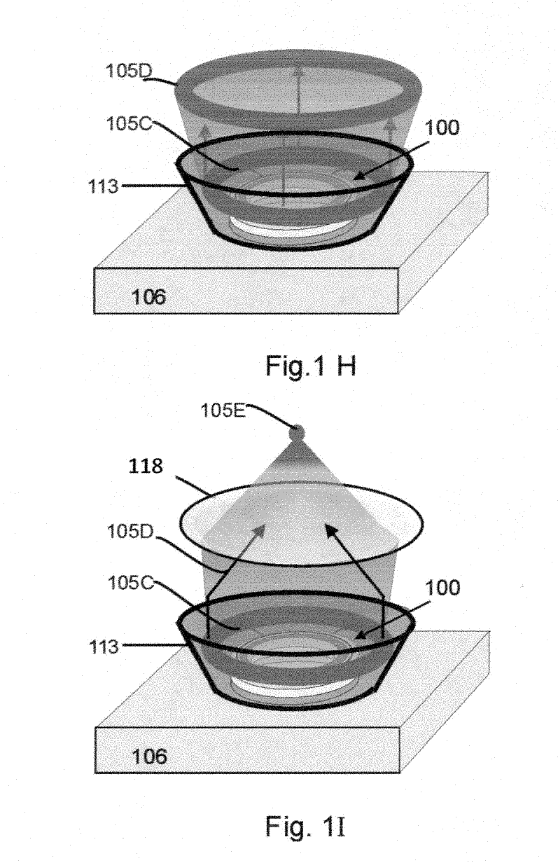

Referring to FIG. 1A, a schematic is shown illustrating a top down view of a cylindrical ring resonator 100 formed by cylindrical ring media 102 with inner region 101 and outer region 103. The refractive index profile is given illustrating that the refractive index of layer 102 is higher than that of region 101 and 103 forming a cylindrical waveguide in the radial direction with inner radius Rin and outer radius Rout, with interfaces 102 B and 102 A respectively, with surface 102A at the interface of layers 102 and 103 forming an output mirror or output coupler surface extending in the axial dimension to allow the circulating modes to radiate energy as prescribed by their respective Q factor. The radial dependency of the classes of radial modes supported by the cylindrical ring resonator are illustrated as a function of their respective Q-factors, with high Q-factor modes (Whispering Gallery Modes) having intensity profiles located along the outside circumference of the cylindrical ring 102, where lower Q-factor modes have intensity profiles which extend to smaller radii within cylindrical ring resonator, with the lowest Q-factor modes having appreciable intensities starting at the inner radius (Rin) and continue to the the outer radius (Rout) of the cylindrical ring waveguide 102. Intermediate Q-factor modes have field patterns starting at more central radii and extend to the outer radius of the cylindrical ring resonator. These radial modes travel around the cylindrical ring resonator occupying radial space as indicated, with varying radial emission components. A ray diagram is included to illustrate how high Q-factor modes (including WGMs) can be viewed as pencils of light rays 105A possessing angles of incidence at the outer interface of layers 102 and 103 which exceed the critical angle and subsequently are totally internally reflected. In contrast, a partial ray diagram is given for a low Q-factor mode illustrated by 105B and is shown to have a lower angle of incidence at the outer interface resulting in a greater radial emission component exiting the output coupler. Media 102 contains an optically active media ether confined to or actuated within a radial ring thereby forming a gain confining region 104, the overlap of region 104 with the various radial mode intensities determines the individual modal gains of the radial modes supported by the cylindrical ring resonator. By restricting the gain confining region to an annular region overlapping with the radial mode intensity profiles of selected Q-factor modes, radial emission can be optimized. Lasing is achieved with the modal gain of selected modes meets or exceed the modal loss of a particular mode which is related to the modal Q-factor. The cylindrical ring laser resonator can be tailored for efficient circumferential laser radiation or as a light emitting diode depending upon the level of actuation and the tailored modal constituency. The emission efficiency can also be optimized by including an optical coating 102A at the outer interface 102A and or a reflective optical coating at the inner interface 102B. Power scaling is accomplished by increasing the overall diameter of the cylindrical waveguide while maintaining the ring waveguide annular width, and tailoring the radial refractive index profile to produce a similar radial mode constituency, thus enabling an increase in total output radial power for fixed power and thermal densities within the resonator and at the output mirror.

Referring to FIG. 1B, there is shown one example of a semiconductor laser apparatus 100A in accordance with the present disclosure. The apparatus 100A in this example makes use of a semiconductor laser epitaxial media following a diode laser configuration formed by an n-type semiconductor substrate 106, an n-type cladding and waveguide layers 107,108, an active layer 109 (comprising of a single layer of direct bandgap semiconductor, quantum well region or quantum dot region), a p-type waveguide layer 110, a p-type cladding layer 111 and a p-type contact layer 112. The respective waveguide and cladding layers establish an axial waveguide establishing one or more axial modes overlapping with the active layer 109. A cylindrical ridge waveguide is formed in the semiconductor epi-layers by etching a circular ring of inner diameter D and outer diameter D+ΔR extending into the semiconductor in the axial dimension, which establishes a radial waveguide, comprising of a annular core 102, inner cladding region 101 and outer cladding region 103 as if FIG. 1A. The injected current is limited to annular region 104 ether by limiting the contact opening or by limiting the extent of the p-type to a radius smaller than the cylindrical ring outer radius, thereby forming a gain confining region within the active layer. When a bias is applied between contact 116 and 117, a diode current is establishes injecting electrons and holes into the active layer, producing optical amplification. The optical gain is restricted to a gain confining region to offset the modal confinement factors (related to the overlap between the radial optical intensity profile and the radial gain profile for a particular mode) thereby favoring amplification of intermediate Q-factor modes over that of low Q-factor modes and or high Q-factor modes to support efficient radial laser emission 105. The device is cooled by heat extraction through the substrate 106.

Referring to FIG. 1C the cylindrical ring laser device 100B is of a semiconductor type according to FIG. 1B, with the top electrode 104a tailored in both the azimuthal and radial dimension. A central contact pad 104b is formed in the center of the ring overlapping the segmented current contacts positioned on top of the cylindrical ring waveguide 102. A common electrode 113 contacting the central region makes electrical contact to all the segmented electrode sections. Application of a bias potential between the top 117 and bottom 116 electrodes results in a forward current flow injecting electrons and holes into the active layer 109, substantially limited to 104a gain confining regions within the active layer 109. The gain confining regions may include selective p-type doping in layers 110,111 and 112 to limit current spreading.

FIG. 1D illustrates a cross-sectional view of the laser resonators 100A and 100B in accordance with FIGS. 1B and 1C. The cylindrical ring resonator width is defined by the region extending from an inner diameter D1 to an outer diameter D2 formed by etching the semiconductor epitaxial structure to selected axial depths. In this configuration the outer surface of the ring resonator extends below the active layer 109, this surface is the outer mirror where radial emission 105 exits the resonator, and may be coated with an optical semi-reflective coating. The top electrode contact segments are formed by a top electrode 104 isolated by a a non-continuous oxide layer 114. Application of a bias potential causes current to flow between the top 117 and bottom contact 116, the ring and segmented type top electrode tailor the current injection profile 115 at the active layer 109 defining the gain confining region. As the current flows toward the active layer 109, it spreads out from the electrode ring or segment. Current spreading can be reduced by selective p-type doped regions located under the contact segments, with the regions outside the contact segments undoped or slightly n-type doped (layers 110-112). The resultant gain tailoring in both radially and azimuthal dimensions offset the radial and azimuthal modal confinement factors to select a subset of modes supported by the resonator for amplification and subsequent lasing.

FIG. 1E illustrates the radial refractive index profile of the device of FIG. 1D with a multi-level radial etch profile forming resonator 100B. The index of refraction in region 102 is higher than that of region 101 and 103 thus forming a cylindrical ring waveguide extending from diameter D1 to diameter D2, capable of supporting a multitude of radial modes possessing a range of Q factors including, High Q-factor Whispering Gallery Modes which have radial modal intensity patterns located at the outside cylindrical surface and Radial emitting modes with lower Q-factors having intensity profiles within the cylindrical ring waveguide, as depicted. The “Tailored Current Profile” 115 is shown to support optical gain within regions of the active layer 109 establishing a gain confining region which overlaps selectively with the Radial Emitting Modes (low-intermediate Q-factor mode) with minimal to zero overlap with the Whispering Gallery Mode or high Q-factor mode, thereby favoring amplification of selected modes. The semiconductor epitaxial layer design is shown to support a single axial mode signified by the Gaussian “Axial Mode Intensity” region. The radial emission 105 at the output coupler is located along the circumferential outer surface (of diameter D2) and is defined by three-dimensional modal profile.

FIG. 1F shows a radial cross-sectional view of a semiconductor cylindrical ring ridge waveguide of FIG. 1B including a multi-step ridge etch 100C. The semiconductor cylindrical resonator 100C is defined by 3 etches of diameters D1, D2 and D3 with respective surfaces 102A,102B and 103 thereby establishing an effective index profile (shown in FIG. 1G) in the radial dimension. The cylindrical wave guide is formed by regions 101, 102A and 102B, with the index of refraction of region 102A higher than that of region 101 and that of 102B. The refractive index step Δn between the waveguide layer 102A and outer region 102B can be tailored by changing the depth of etched regions with respect to the active layer 109. The output coupler surface located at D3 is of larger diameter than the outer diameter of the cylindrical ring waveguide defined by D2 where the index step Δn is not defined by the material differences between layers but by the corresponding etch depths. The radial intensity profiles of both high Q modes (WGMs) and radial emitting modes are illustrated along with the axial mode intensity profile. The Tailored current profile establishing the gain confining region within the active layer 109 is seen to overlap substantially with the selected modal set over the WGMs.

Referring to FIG. 1H, a cylindrical ring laser 100 is shown in accordance with the invention capable of circumferential radiation 105C, with the circumferential radiation being redirected vertically 105D with an angled reflective conical three-dimensional mirror 113.

Referring to FIG. 1I, a cylindrical ring laser 100 is shown in accordance with the invention capable of circumferential radiation 105C, with the circumferential radiation being redirected vertically 105D with an angled three dimensional reflective conical mirror 113 and focused or collimated by an optical component 118 to a concentrated spot 105E or collimated beam (not shown).

Referring to FIG. 1J a series of cylindrical ring laser elements are configured concentrically, the central ring given by 100-1, next outer ring 100-2 and outside ring 100-3, in cross section. Each cylindrical ring laser is configured to laser radially in accordance with the present disclosure, each ring of emitted light exiting the outer circumference of their respective cylindrical ring resonator is reflected by a conical mirror 113, with the inner conical mirror 113A, middle conical mirror 113B and outer conical mirror 113C, to form a nested ring of light exiting perpendicular to the nested cylindrical ring lasers. In the scenario all the nested cylindrical ring lasers share the same semiconductor substrate 106, which is cooled on heat sink 210. The reflected laser light propagating normal to the laser surface forms a bulls eye pattern.

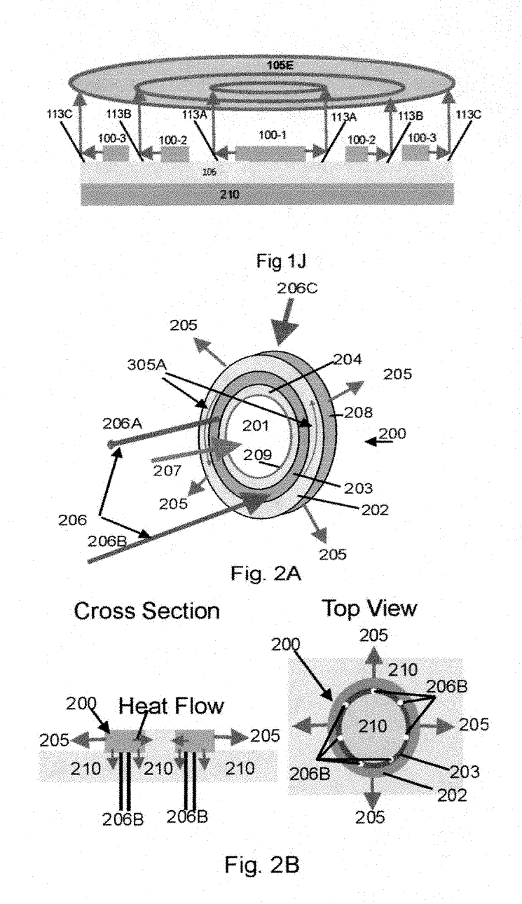

FIG. 2a shows a laser system 200 representing a concentric cylindrical laser architecture formed by a multi-concentric layered cylindrical solid state disk. The solid-state matrix used to make the cylindrical resonator 200 contains a homogeneous gain loaded matrix or a multi-layer matrix consisting of distinct layers of radially varying Rare Earth dopant concentrations and refractive indices. The solid state cylindrical disk is comprised of a multiple concentric layers (201,202,203 and 204) of finite thickness in the axial dimension. The layers are designed to form a cylindrical ring resonator with the refractive index of layers 202,203 and 204 higher than the inner region 201 and outer region, thus forming a cylindrical ring optical waveguide providing both radial and axial optical confinement. The cylindrical waveguide may include an outer optical coating 208 and an inner optical coating 209 to optimize laser emission. The waveguide includes a gain confining region 203 consisting on any overlapping gain media (containing at least one Rare Earth dopant) and pump radiation. The Rare Earth dopants may include, but are not limited to, one or more of Erbium (Er), Ytterbium (Yb), Neodymium (Nd); Thulium (Tm); Praseodymium (Pr); Cerium (Ce); Holmium (Ho); Yttrium (Y); Samarium (Sm); Europium (Eu); Gadolinium (Gd); Terbium (Tb); Dysprosium (Dy); and Lutetium (Lu). Transition metals such as Chromium (Cr) and Titanium (Ti) may also be incorporated. The gain region is actuated by optical pumping 206 for a high energy source capable of exciting the active layer. The optical pumping can be accomplished by one or more optical fibers 206A directing light to the active layer, alternatively by free space illumination 206B,206C. Efficient pumping schemes would require multiple free space pump beams which may be redirected back onto the gain regions with a series of mirrors.

In accordance with the laser architecture of FIG. 2A, the cylindrical resonator 200 is configured with a hollow center allowing access for a liquid coolant 207 to flow thru the device for heat removal.

In accordance with the laser architecture of FIG. 2A, the solid state cylindrical ring waveguide comprises a uniformly homogeneous gain loaded matrix for layers 202, 203 and 204 formed from laser glass or suitable laser substrate doped uniformly with Rare Earth dopants, whereby nonuniform optical pumping is utilized to form the radially confined gain region 203, by confining pump illumination to the annular ring limiting optical amplification substantially to an annular ring 203 of width less than the annular ring width of the cylindrical ring waveguide.

FIG. 2B shows a solid state laser 200 of FIG. 2A positioned on a heat removing substrate 210, which may be liquid cooled on the bottom surface to help extract heat from the solid state cylindrical laser 200. Optical pumping is provided by pump fibers 206B for efficient optical pumping of the gain media 203 with a selected gain confinement region 203. The location of multiple optical pump fibers 206B are illustrated in the top view to overlap with the gain confining region. The laser is shown to laser circumferentially 205 in accordance with this disclosure.

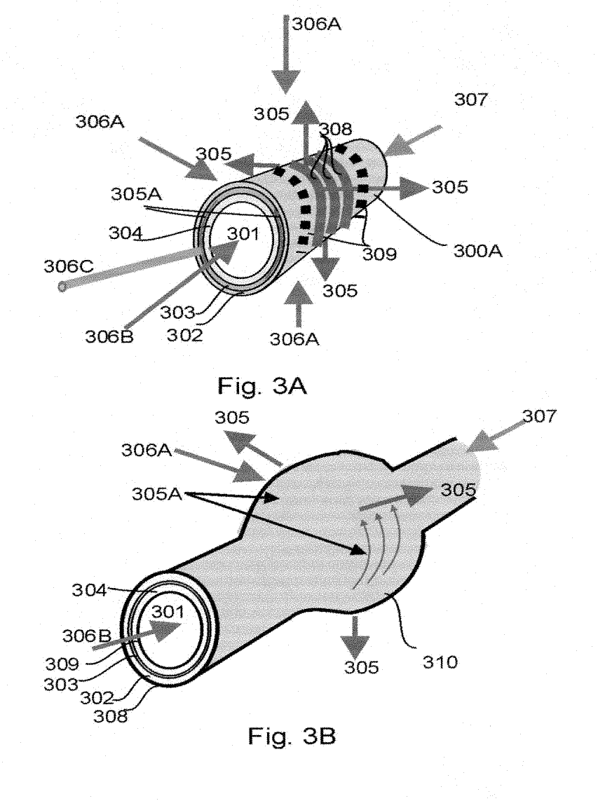

FIG. 3A shows another embodiment of this disclosure, a multi-layer solid state cylinder ring resonator consisting of multiple concentric layers (301,302,303,304) in the geometric shape of a cylindrical tube. The multi-layers of varying refractive index including at least active one layer forming a cylindrical optical waveguide between layers 301-304, with layers 302,303 and 304 with greater refractive index over layers 301 and the outside ambient region. Traveling wave modes are setup in the cylindrical ring resonator traveling circumferentially in both the clockwise and counterclockwise directions 305A. The gain region consisting of a solid state layer doped with a Rare Earth dopant 303 forming a gain media, the overlap of the gain media and pump radiation forms the gain confining region. The pump radiation is provided by ether one or more optical fibers 306c or by free space illumination 306A,306B. The gain confining region 303 is designed to preferentially overlap with radial modes possessing a significant radial component, the axial modes are limited by attenuation lines 309 to provide axial confinement. The laser emits circumferential radiation with sufficient pump radiation.

In accordance with the laser architecture of FIG. 3A, the cylindrical resonator of FIG. 3A includes a hollow center, enabling flow of liquid coolant 307 to remove heat from the resonator.

FIG. 3B shows a cylindrical ring laser in accordance with the laser architecture of FIG. 3A, including a bottle resonator 310 geometry to provide axial optical confinement.

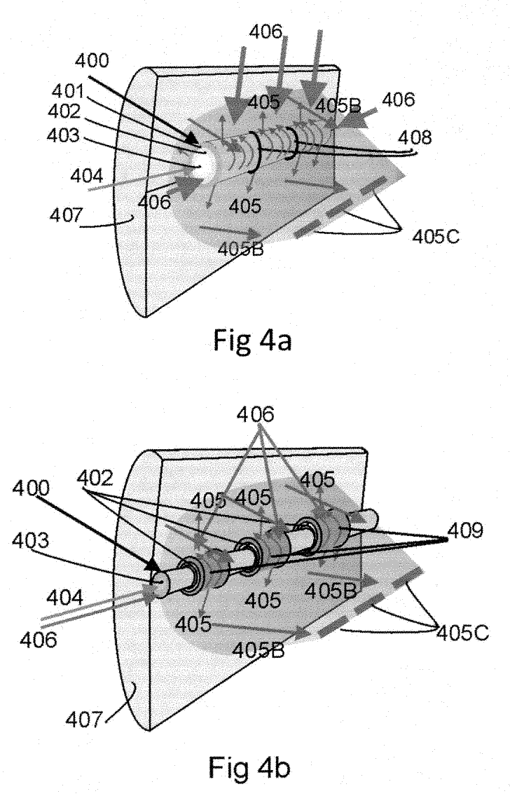

FIG. 4 shows a cylindrical ring laser 400 in accordance with this disclosure positioned within a three dimensional cylindrical mirror 407 for reflecting and concentrating the circumferential laser emission 405. Pump radiation is provided by free space pumps 406 and liquid coolant 404 flows through the central region of the resonator. The multi-cylindrical layered resonator features concentric layers 401,402,403, including a gain media 402 establishing a radial refractive index profile providing radial optical confinement. Axial confinement is established by attenuation lines 408. The radial emission 405 of the laser resonator 400, is reflected 405B by the three-dimensional mirror 407 to form a concentrated line segment 405C.

FIG. 4B shows a multi-element 409 cylindrical ring laser with elements stacked in the axial dimension, providing axial modal confinement.

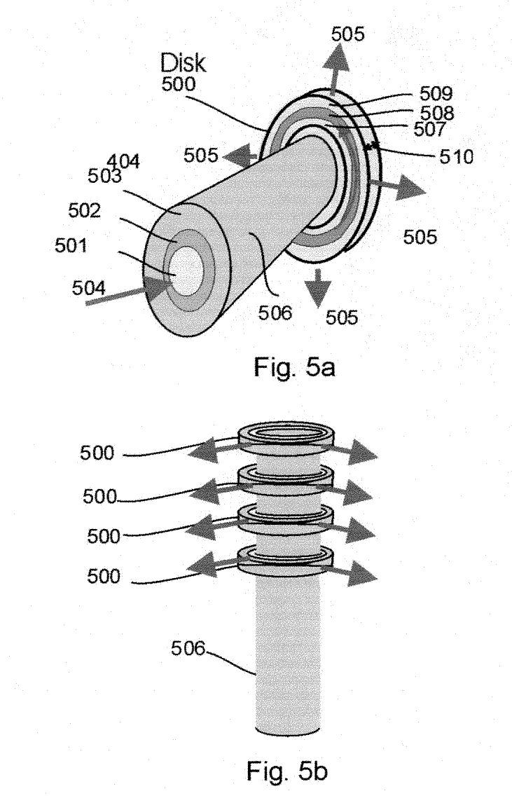

FIG. 5a shows another embodiment of a laser architecture in accordance with this disclosure, featuring a gain and index guided micro-cylindrical ring resonator in a disk geometry 500 attached to a single optical fiber 506 of axial thickness 510. The optical fiber 506 has inner core 501 and cladding layers 502,503 to form a guided light pipe delivering optical pump light to the cylindrical ring laser resonator located at the distal end of the fiber. The micro-disk resonator features a multi-layered 507,508,509 cylindrical disk with radial index of refraction profile tailored to confine a plurality of radial modes, the gain media region 508 is tailored to offset the modal gain factors of the radial mode set to favor amplification of a subset of radial modes which support efficient radial emission 505. Pump energy is delivered by the optical fiber 506.

FIG. 5b shows a cylindrical ring laser in accordance with the laser architecture of FIG. 5A with multiple micro-disk resonators 500 stacked in the axial dimension.

The foregoing description of the various embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules and systems. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above described embodiments that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

What is claimed is:

1. A solid state laser apparatus comprising:
at least one cylindrical ring optical waveguide for providing optical confinement in radial and axial directions supporting a plurality of traveling wave modes comprising of independent radial and axial modes with degenerate azimuthal modes circulating around said cylindrical ring waveguide with varying radiation loss;
a gain media located within the optical waveguide;
at least one pump source overlapping with said gain media to generate photons within a gain confining region, said gain confining region limited in radial dimension to an inner radius greater than or equal to that of the inner radius of said cylindrical ring waveguide with an outer radius substantial less than the outer radius of said cylindrical ring waveguide, whereby said gain confining region has a geometry which is substantially matched to intensity profiles of a subset of radial modes thereby providing a modal gain difference between the selected radial mode subset and remainder of radial mode components of said traveling wave modes thereby favoring amplification of a modal subset capable of supporting circumferential radiative emission in the radial direction, an output coupler surface enabling the circumferential radial emission to exit the laser cavity, and a heat sink coupled to the cylindrical ring laser resonator.

2. The laser apparatus of claim 1 further comprising of optical coatings applied onto one or both axial surfaces of said cylindrical ring waveguide including said circular output coupler outer surface.

3. The laser apparatus of claim 1 where the pump source includes one or more of the following: optical fibers, optical fiber bundles, holely fibers, light pipes, free space photonic radiation, multi-beam free-space laser radiation and lamp radiation for delivering photonic pump radiation to said gain confining region.

4. The laser apparatus of claim 1 wherein the solid state material includes or at least one type of transition metal, or a combination of at least one type of Rare-Earth dopant and at least one type of transition metal, from the following: Erbium (Er), Ytterbium (Yb), Neodymium (Nd), Thulium (Tm); Praseodymium (Pr); Cerium (Ce); Holmium (Ho); Yttrium (Y); Samarium (Sm); Europium (Eu); Gadolinium (Gd); Terbium (Tb); Dysprosium (Dy); Lutetium (Lu); Chromium (Cr) and Titanium (Ti).

5. The laser apparatus of claim 1 whereas the cylindrical ring waveguide includes a multi-layered concentric cylindrical disk geometry extending in the axial dimension about a uniform central region, with each layer comprising of an annular geometric region of a select radial width and uniform axial dimension, each layer consisting of a uniform media and index of refraction, placed one inside another thus forming the multi-layered media, with the total radial refractive index profile forming a radial waveguide capable of supporting a plurality of radial modes.

6. The laser apparatus of claim 1 whereas the cylindrical ring waveguide includes stacked media layers in the axial dimension of selected index of refraction and thickness with at least one layer containing a gain media, whereby the axial refractive index profile of said stack forms an axial waveguide capable of supporting at least one axial mode substantially overlapping with said gain media.

7. The laser apparatus of claim 1, including multiple gain confining regions confined in both the radial and azimuthal dimension whereby the gain region is defined by the overlap of said pump source and gain media, being limited by one of or both said pump source location or gain media location.

8. The laser apparatus of claim 1 wherein the said modal gain is sustained below laser threshold levels, supporting predominantly spontaneous emission over stimulated emission, thereby creating a circumferential light emitting diode.

9. The laser apparatus of claim 1, wherein the cylindrical ring waveguide includes distributed Bragg reflectors positioned to reflect a subset of traveling wave modes.

10. The laser apparatus of claim 1, wherein the cylindrical ring waveguide includes a series of distributed attenuation lines extending in the axial dimension, positioned periodically around the cylindrical ring waveguide spanning an inner radius substantially greater than the inner radius of said cylindrical ring waveguide to a radius equal to the outer radius of said cylindrical ring waveguide, whereby the radial extent of said attenuation lines are substantially matched to the radial intensity profiles of a subset of radial modes possessing high Q-factors, thereby creating a distributed loss for said subset of traveling wave modes consisting of high Q factors.

11. The laser apparatus of claim 1 wherein the cylindrical ring waveguide includes an axially varying diameter, thereby forming a bottle of disk shaped geometry establishing a axially varying index of refraction profile, with cylindrical ring waveguide capable of supporting at least one axial mode.

12. The laser apparatus of claim 1 including an external three-dimensional reflector for redirecting and or concentrating the circumferential radial laser emission.

13. The laser apparatus of claim 1 consisting of multiple concentric cylindrical ring waveguides formed one inside the other with independent pump sources capable of supporting independent radial laser emission, thereby forming a concentric cylindrical ring laser array, wherein the laser radiation from each element of the concentric cylindrical ring laser array is reflected by one of a plurality of concentric three-dimensional conical mirrored reflectors of increasing diameter, thereby forming a multi-ringed laser beam propagating in the axial direction away from the surface of the laser array, one laser output ring corresponding to each laser element.

14. The laser apparatus of claim 1 consisting of multiple cylindrical ring waveguides stacked in the axial direction about a common central cylinder structure, thereby forming a cylindrical ring laser array, said century cylinder structure capable of delivering pump energy and or liquid coolant to each of the individual laser elements.

15. The laser apparatus of claim 1 wherein the geometric size of said cylindrical ring optical waveguide is substantially larger than the optical wavelength supported by said active layer.

16. The laser apparatus of claim 1 wherein the geometric size of said cylindrical ring optical waveguide is on the order of the optical wavelength supported by said active layer, thereby forming a micro-resonator.

17. The laser apparatus of claim 1 whereby coolant is provided through the central region of the cylindrical ring waveguide.

18. The laser system of claim 1 wherein the cylindrical ring waveguide includes a micro-disk geometry positioned at the distal end of an optical fiber, whereby said cylindrical ring waveguide is positioned at the distal end of an optical fiber providing optical pump radiation to said cylindrical ring waveguide.

19. A semiconductor laser apparatus comprising: at least one cylindrical ring optical waveguide structure of selected radial width and diameter providing optical confinement in both the radial and axial dimensions, said optical waveguide including a multi-layered epitaxy grown on a suitable substrate consisting of an active layer stacked in the axial dimension between first and second layers, said first layer including a dopant one of n-type and p-type and said second layer doped the other n-type or p-type including gain confining region, whereby said gain confining region has a radial width that is less than said selected width, said optical waveguide capable of supporting a plurality of radial modes, one of a plurality of axial modes and a plurality of degenerate azimuthal modes, electrical contacts for providing current for the active layer, wherein said gain confining region has a geometry which is substantially matched to intensity profiles of a subset of modes of said plurality, thereby providing a modal gain difference between the selected mode subset and remainder of said mode plurality, wherein said gain confining region has a radial width that is less than the width in the radial direction to which said radial modes supported by the cylindrical ring waveguide extend, a circular output coupler enabling the circumferential radiative emission to exit the device said output coupler comprising of a circular axial surface exposing the active layer edge at a radius equal to or greater than the outer radius of said cylindrical ring waveguide with said surface containing an optical coating.

20. The laser apparatus of claim 19 wherein said optical waveguide includes a circular ridge waveguide structure with a selected cylindrical ridge width and diameter in the radial dimension and wherein said gain confining region has a radial width that is less than said selected width.

21. The laser apparatus of claim 19 wherein said cylindrical ring optical waveguide includes a buried waveguide structure.

22. The laser apparatus of claim 19 wherein said gain confining region is defined by the volumetric extent of the doped region within said second layer doped the other of n-type or p-type of said first layer, whereby said volumetric extent is limited in the radial dimension to a radial with less than the radial width of said cylindrical ring optical waveguide.

23. The laser apparatus of claim 19 whereas the gain confining region further comprises multiple geometric sectors positioned around the cylindrical ring waveguide centered on azimuthal angles defined by integral fractions of 360 degrees.

24. The semiconductor laser apparatus of claim 19 wherein said gain confining region is defined by the location and geometry of top electrical contacts to said second layer, thereby substantially limiting current injection into said active layer to regions substantially aligned with said top electrical contact.

25. The laser apparatus of claim 19 whereby a top electrical contact to said second layer is formed between two insulated circular notches within the cylindrical ring waveguide region extending in the axial direction spaced in the radial dimension for defining the gain confining region therebetween.

26. The laser apparatus of claim 19 wherein said gain confining region includes multiple gain confining regions limited geometrically in both the radial and azimuthal direction within said cylindrical ring waveguide, thereby limiting current injection into the active layer to said gain confining regions.

27. The laser apparatus of claim 19 wherein the said modal gain is sustained below laser threshold levels, supporting predominantly spontaneous emission over stimulated emission, thereby creating a circumferential light emitting diode.

28. The laser apparatus of claim 19 further comprising a three dimensional conical reflector, whereby the cylindrical ring laser is placed concentrically within a three-dimensional conical mirror to reflect radiation emanating from the active layer, thereby forming a ring of light propagating in the axial direction away from the surface of the device.

29. The laser apparatus of claim 19 including multiple concentric cylindrical ring waveguides of increasing diameter with independent electrical contacts and output coupler surfaces thereby forming a concentric cylindrical ring laser array, with each individual cylindrical ring laser element supporting independent radial laser emission, wherein the laser radiation from each element of the concentric cylindrical ring laser array is reflected by one of a plurality of concentric three-dimensional conical mirrored reflectors of increasing diameter, thereby forming a multi-ringed laser beam propagating in the axial direction away from the surface of the laser array, one ring corresponding to each laser element.

30. A method of forming a laser apparatus supporting circumferential radiation, comprising the steps of: providing an active material; optically confining the laser in the radial and axial dimension such that the laser can support a plurality of traveling wave modes comprising of at least one of a plurality of axial modes, a plurality of radial modes and a plurality of degenerate azimuthal modes; producing optical gain in the active material; and confining the optical gain to a region that substantially matches for each plurality of modes supported, a selected subset of modes of the plurality of modes more than at least one other mode of the plurality for providing a modal gain difference between selected modes and the remainder of the plurality of modes for favoring excitation of the selected modes which support efficient radial emission; providing a output pathway for the circumferential laser light to exit the laser apparatus; providing an external reflective mirror for reflecting the radially emitted radiation normal to the surface of the laser apparatus.

31. The method of claim 30 wherein the step of providing an active material includes providing an active semiconductor layer, and wherein the step of optically confining the laser in the axial direction includes providing additional layers stacked in the axial direction with the active layer having an index of refraction lower than that of the active layer, and the method of providing optical confinement in the radial direction includes providing a circular ridge waveguide structure with etched channels extending in the axial direction of said semiconductor, the method of producing optical gain in the active material includes providing top and bottom electrical contacts to allow current flow through the stacked layers with radiative recombination taking place within the active layer, the method of providing a modal gain difference includes limiting the geometric extent in the radial and azimuthal dimensions of injected carriers into the active layer to regions which substantially overlap with intensity profiles of a select subset of modes, while not providing current to regions which substantially overlap with the remainder of the plurality of modes, the method of providing a output pathway for the circumferential laser light includes etching a cylindrical trench into said semiconductor extending in the axial dimension at a radius greater than or equal to the outer radius of said cylindrical ring waveguide thereby exposing an active layer surface; the method of providing an external mirror for reflecting the radially emitted radiation normal to the surface of the laser apparatus includes placing the cylindrical ring laser inside a concentric three-dimensional conical mirror whereby the incident radial emission exiting said active layer is reflected by said mirror in the axial direction away from the surface of said laser device.

32. The method of claim 30 wherein the step of providing an active material includes providing a doped solid state matrix including at least one type of transition metal, or a combination of at least one type of Rare-Earth dopant and at least one type of transition metal, from the following: Erbium (Er), Ytterbium (Yb), Neodymium (Nd), Thulium (Tm); Praseodymium (Pr); Cerium (Ce); Holmium (Ho); Yttrium (Y); Samarium (Sm); Europium (Eu); Gadolinium (Gd); Terbium (Tb); Dysprosium (Dy); Lutetium (Lu); Chromium (Cr) and Titanium (Ti), and the method of providing optical confinement in the radial direction includes providing a multi-layered cylindrical media with each layer formed by a solid state media of annular ring geometry positioned concentrically one inside another extending in axial dimension, the step of providing optical confinement in the axial dimension includes limiting the gain media or pump region to a axial extent, the method of producing optical gain in the active material includes providing an optical pump overlapping with said gain media, the method of providing optical confinement in the axial dimension includes limiting the extent of the gain media, pump illumination or both in the axial dimension, the method of providing a modal gain difference includes limiting the geometric extent of the overlap between said pump and gain media to regions within said cylindrical waveguide which substantially overlap with intensity profiles of a select subset of modes over that of the remainder of said plurality of modes, the method of providing a output pathway for the circumferential laser light includes coating the outer axial surface of said cylindrical ring waveguide with an optical coating, the method of providing an external mirror for reflecting the radially emitted radiation normal to the surface of the laser apparatus includes placing the cylindrical ring laser inside a concentric three-dimensional conical mirror whereby the incident radial emission exiting said active layer is reflected by said mirror in the axial direction away from the surface of said laser device.
